(19) United States
(12) Patent Application Publication
(10) Pub. No.: US 2013/0343613 A1
(43) Pub. Date: Dec. 26, 2013

(54) CAMERA-BASED METHOD FOR DETERMINING DISTANCE IN THE CASE OF A VEHICLE AT STANDSTILL

(71) Applicants: Thomas Heger, Leonberg (DE); Michael Helmle, Esslingen (DE)

(72) Inventors: Thomas Heger, Leonberg (DE); Michael Helmle, Esslingen (DE)

(21) Appl. No.: 13/991,917

(22) PCT Filed: Dec. 1, 2011
(86) PCT No.: PCT/EP2011/071545

§ 371 Date: Sep. 9, 2013

(30) Foreign Application Priority Data
Dec. 8, 2010 (DE) 102010062589.2

(51) Int. Cl. G06K 9/00

(52) U.S. Cl. CPC G06K 9/00791
USPC 382/106

(57) ABSTRACT

Methods for distance determination, as are used, for example, in parking assistance systems are described. In a vehicle at standstill, the method involves detecting a first predefined event that occurs in connection with a pitching motion of the vehicle, and based on the detection of the first event, activating the camera in order to record a first and a second image of the vehicular environment and include a time reference to the pitching motion. The method also includes processing the first and the second image in order to determine a distance to the object from a displacement of the object in the field of view of the camera that has taken place between the points in time of the recording of the first and second image in response to the pitching motion.

### FIELD OF THE INVENTION

The present invention relates to methods for determining distance, as are used, for example, for parking assistance systems or other subsystems of a driver assistance system.

### BACKGROUND INFORMATION

The present invention relates to methods for determining distance, as are used, for example, for parking assistance systems or other subsystems of a driver assistance system. Driver assistance systems include auxiliary devices in motor vehicles to provide assistance to the driver in certain driving situations. To this end, a driver assistance system frequently includes subsystems, such as an ABS (antilock system r an ESP (electronic stability program), but also an intelligent cruise control (“active cruise control,” ACC) or a parking assistance system for pulling into, respectively backing out of a parking space, for example. The last-mentioned subsystems, in particular, require that a distance to objects in a vehicular environment be determined, for instance, to warn the driver about obstacles or, in the case of an active longitudinal and/or lateral guidance, to adapt the trajectory accordingly.

A distance determination in a vehicle in motion or also at standstill is known that is based on an ultrasonic sensor system. However, a distance determination based on an image sensor system is also possible. Besides the use of a stereo camera or a plurality of cameras that are mounted on the vehicle at a mutually spaced distance on the vehicle, a distance can also be determined on the basis of a series of images recorded by a mono-camera. In such a case, a sequence of images recorded by the camera is analyzed to check for the presence of an “optical flow” (On) for an object, as results, for example, when an object approaches in the field of view of the camera. A distance can be inferred from the OFL, i.e., from a change in the apparent size of the object. These types of methods are carried out on the assumption that the vehicle moves either relative to the ground (road surface) and/or relative to the object.

It is desirable that a camera-based distance determination also be possible for a vehicle at standstill (for example, parked) in relation to a stationary object, for example, to enable a parking assistance system, in the case of a vehicle that is still at standstill, to alert the driver to too small of a distance to a parking-space limiting object or to calculate a trajectory for backing out of the parking space. For this purpose, camera-based methods require a plurality of cameras or one stereo camera. The German Patent Application DE 10 2005 036 782 A1 describes another method that uses just one mono-camera. in this case, two recorded images of a vehicle's surrounding field are produced. Between. these two recorded images, a relative movement must have taken place between the camera and the vehicle's surrounding field. In the case of a motor vehicle at standstill, a system is provided where the camera is not fixedly mounted to the vehicle, rather a rail system is employed to allow it to move relative to the vehicle and, thus, relative to the vehicle's surrounding field. A measuring sensor system records a relative movement between the camera and the vehicle, and thus relative to the surrounding field. This makes a distance measurement possible in the case of a stationary vehicle.

The aforementioned camera-based Methods, respectively systems, are relatively complex because they require either a plurality of cameras, at least one stereo camera, or a complicated mechanical, error-prone installation of a camera on a rail system.

### SUMMARY

There is a need for a camera-based method for determining distance to an object in a vehicular environment in the ease of a vehicle at standstill that is less complicated and less prone to errors, and thus more cost-effective than the known methods described above.

In accordance with the present invention, a camera-based method is provided for determining a distance to an object in a vehicular environment in the case of a vehicle at standstill, that includes the following steps: detecting a first predefined event that is associated with a pitching motion of the vehicle; based on the detection of the first event, activating the camera, in order to record a first and second image of the vehicular environment and include a time reference to the pitching motion; and processing the first and second image in order to determine a distance to the object from a displacement of the object in the field of view of the camera that has taken place between the points in time of the recording of the first and second image in response to the pitching motion.

In certain. specific embodiments of the present invention, the first image is recorded before or during the pitching motion, and the second image subsequently thereto during or subsequently to the pitching motion.

The first event may include one or a plurality of the following events: unlocking of a vehicle door, where it may be a question, for example, of a driver-side door, passenger-side door, trunk door or also of a side door, for instance, in the case of a bus; it being possible for the unlocking to be either mechanical or electronic, or remotely operated unlocking of the vehicle door, for example; opening of a vehicle door; change in a weight loading upon a vehicle seat, that may be determined, for example, by a corresponding sensor system on the vehicle seat, passenger seat, etc; the vehicle lowering in response to a person entering, the loading of a load, etc.; it being possible for a sensor system at one or a plurality of wheel suspensions to detect the lowering, for instance.

To establish that the first event has occurred, it may be necessary for at least one further predefined condition to be realized. For example, a detection of the first event may be based on the vehicle being at standstill, respectively parked. This, in turn, may be detected on the basis, for instance, of the engine being switched off and/or a hand brake being pulled, etc. A plurality of the aforementioned conditions may be combined, the first event not being detected until all of the conditions have been met.

The camera may be continuously activated in response to the detection of the first event. To determine distance, it is not necessary to ascertain a beginning of the pitching motion. It suffices that the first recording be used as a first image, for example, that is produced by the activated camera. To optimize the distance determination, it would be advantageous that the second image be recorded when a vertical displacement of the vehicle is at the maximum thereof, i.e., during a low point of the pitching motion. However, it is likewise conceivable that a recording be used as a second image that is recorded by the camera when the vehicle is again at rest, for example, because a person has sat down on the driver's seat.

In the case of a continuously recorded sequence of images, a maximum displacement of the vehicle may be determined by an image processing which provides fur comparing the position of an object in the field of view of the camera. However, the moment of maximum vehicle displacement resulting from the pitching motion may also be determined by a sensor system on the wheel suspension, for example, and an image that results at this point in time from a continuous sequence of images, or a second image that is selectively produced at this point in time may be utilized for distance determination.

If the camera is not continuously activated in response to the detection of the first event, certain specific embodiments of the method according to present invention provide for the second image to be recorded in response to a detection of a second event that is at least indirectly associated with the pitching motion. In this case, the second event may include: the closing of a vehicle door, for example, a driver-side door or a previously opened door that had contributed to the detection of the first event; detection of a constant weight loading upon a vehicle seat (for example, by a sensor system of the driver's seat.) as occurs once the driver is fully seated; and/or detection of a position of rest or of an upward movement of the vehicle, which indicates that the pitching motion is ended. As already noted above, it is not absolutely necessary that the second image be recorded at the maximum (for example, vertical) deflection of the vehicle, rather it may also be generated following the end of a pitching motion under the assumption, for instance, that a driver has entered, and the vehicle thereby sinks down for a continuous period of time. Under these circumstances, the starting of the engine and/or engagement of a gear may, for instance, be defined as the event triggering the recording of the second image.

The method according to the present invention may include the further step of determining an absolute displacement of the camera (in the vertical direction and/or by the rotation of a viewing axis of the camera, i.e., the change in an angle of the camera, for instance, in relation to a horizontal) in response to the pitching motion. The specific absolute displacement is then included in the determination of the distance to the object. The absolute displacement may be determined, for example, from a measurement of the pitching motion, respectively the vertical displacement of the vehicle using a sensor system on the wheel suspension.

The method according to the present invention may be used, for instance, for a practical application in the context of a subsystem of a driver assistance system, such as a parking assistance system. Accordingly, the camera may be a rearview camera of a parking assistance system of the vehicle, for instance. The method according to the present invention makes it possible to determine a distance to another parked vehicle located in the area to the rear of the vehicle or to another parking-space limiting object and alert the driver thereto already when the vehicle is at a standstill, i.e., before the vehicle is backed out of the parking space. Alternatively or additionally, the vehicle may calculate a trajectory based on the distance determination that is suited for an active, respectively at least semi-automatic guidance out of the parking space.

However, the method according to the present invention may also be correspondingly implemented using a simple, forwardly directed camera, and, in this case, likewise renders possible a distance warning, respectively trajectory calculation already when a vehicle is at standstill. However, the camera may also be located in a side-view mirror of the vehicle, for instance. Expedient in this case would be that the triggering event for recording the first image be an event that takes place prior to the opening of the driver-side door; an example of this would be an electronic unlocking of the vehicle door. The triggering event for recording the second image could then be an event such as the closing of the driver-side door, for instance, or another event that usually follows in time, such as the starting of the engine, etc.

In accordance with the present invention, a computer program is also provided, the computer program being provided for implementing one of the methods described here when the computer program is executed on a programmable computer device. The computer device may, for example, be a central processing module (“electronic control unit,” ECU) of a driver assistance system or a module for implementing a subsystem of a driver assistance system, such as a parking assistance system, for instance. The computer program may be stored on a machine-readable storage medium, for instance, on a permanent or rewritable storage medium or be allocated to a computer device of a removable CD ROM, DVD or a USB stick. Additionally or alternatively, the computer program may be provided as a computer device for downloading, for example, via a data network, such as the Internet, for instance, or a communications link, such as a telephone line or a wireless connection.

The present invention also provides for a parking assistance system having a camera that is designed for determining the distance to an object in a vehicular environment in the, case of a vehicle at standstill. The parking assistance system according to the present invention, which, for instance, may be a subsystem of a driver assistance system in the vehicle, has the following components: a component for detecting a first predefined event that occurs in connection with a pitching motion of the vehicle; a component for activating the camera in response to the detection of the first event in order to record a first and second image of the vehicular environment and include a time reference to the pitching motion; and a component for processing the first and second image in order to determine a distance to the object from a displacement of the object in the field of view of the camera that has taken place between the points in time of the recording of the first and second image in response to the pitching motion.

In one specific embodiment of a parking assistance system according to the present invention, the camera is movably mounted on the vehicle in a way that allows a rotational or swiveling motion thereof relative to the vehicle to support the distance determination.

### Advantages of the Invention

The present invention makes it possible to determine a distance to an object in a vehicular environment in the case of a vehicle at standstill using a simple mono-camera that may be fixedly mounted on the vehicle. The present invention is based, inter alia, on the idea that, even in the ease of a stationary vehicle, a pitching motion of the same generates an optical. flow (respectively, “motion flow”) for a fixed camera that may be used for a distance determination. The pitching motion may arise in response to the driver getting into the vehicle or due to a loading operation. Thus, the pitching motion makes it possible to realize a quasi stereo imaging using a mono-camera although the vehicle is stationary. There is no need for a rail system or some other mechanically movable mounting, making it possible for the method according to the present invention to be carried out in a simple and low-maintenance process and, thus, cost-effectively. In specific terms, no additional components or hardware groups are necessary. Rather, the present invention may be implemented using an available mono-camera. The pitching angle, respectively the lowering of the vehicle (i.e., generally the relative movement) may be advantageously measured by an inertial sensor system and/or vehicle-level sensors that are normally already installed in the vehicle.

Moreover, there is no need for implementing any additional sensor systems to trigger the measurements. Rather, here as well, already existing sensor systems may be mounted, that are used, for example, for other driver-assistance subsystems. The present invention may be implemented in this case using simple sensor systems. If the intention is that the distance determination be triggered, for example, only in response to a single event, it suffices, for example, to rely on the opening of the driver-side door. This would already activate a camera to record a continuous image sequence. In this case, the first image of the vehicle surrounding field would simply be the first image of the recorded sequence, while the second image used for distance determination may be identified by the subsequent processing from the sequence. In a simple system, the second image could be recorded in a predefined time period following the first image, for example, one, three, five or ten seconds following the first image.

### BRIEF DESCRIPTION OF THE DRAWINGS

FIG. 1 shows a vehicle equipped with a parking assistance system according to the present invention in an exemplary parking situation.

FIG. 2 shows a schematic representation of functional components of the parking assistance system from FIG. 1.

FIG. 3 shows a method of operation of the parking assistance system from FIG. 2 in the form of a flow chart.

FIG. 4 shows a rotatable camera in accordance with an exemplary embodiment of the present invention.

### DETAILED DESCRIPTION

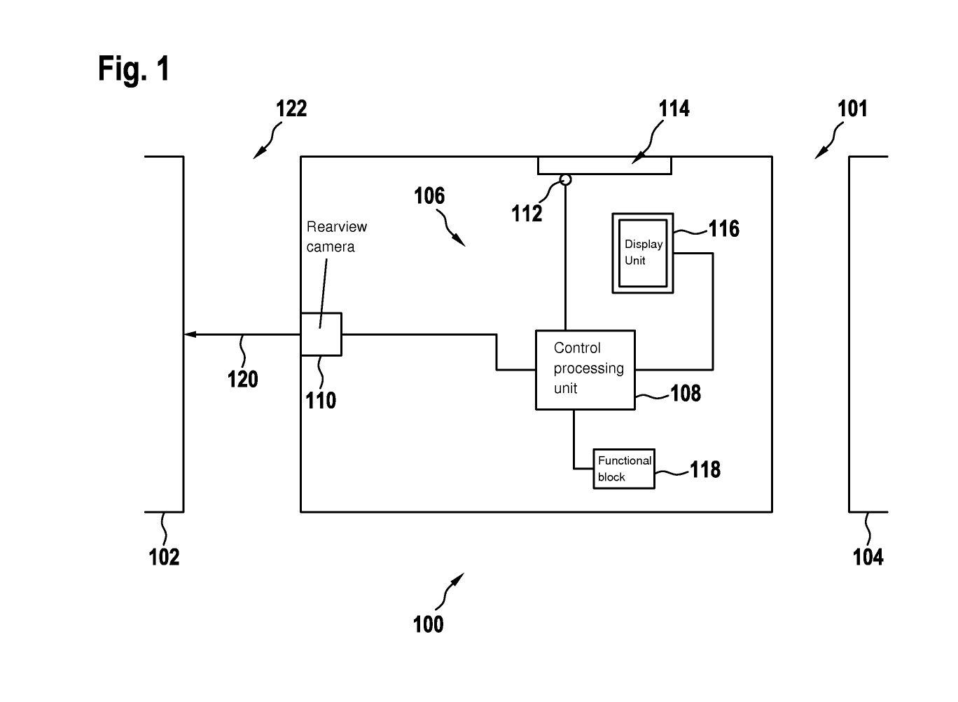

A vehicle 100 in a longitudinal parking gap 101 between two parking-gap limiting objects 102 and 104 is sketched in FIG. 1, where it may be a question of further vehicles. Vehicle 100 is equipped with a driver assistance system (FAS) 106. Some of the components of FAS 106 are indicated and include, in particular, a central processing unit ECU 108, which, inter alia, receives data from a rearview camera 110 configured as a mono-camera, data from a door sensor 112 relating to the state of a driver-side door 114; and which, in turn, outputs data to a display unit 116 for displaying to the driver. In addition, FAS 106 includes an engine control, respectively braking system control indicated schematically as an individual functional block 118 for an active guidance in the ease of a backing out of parking space 101. The present invention is described exemplarily in greater detail in the following on the basis of the situation sketched in FIG. 1.

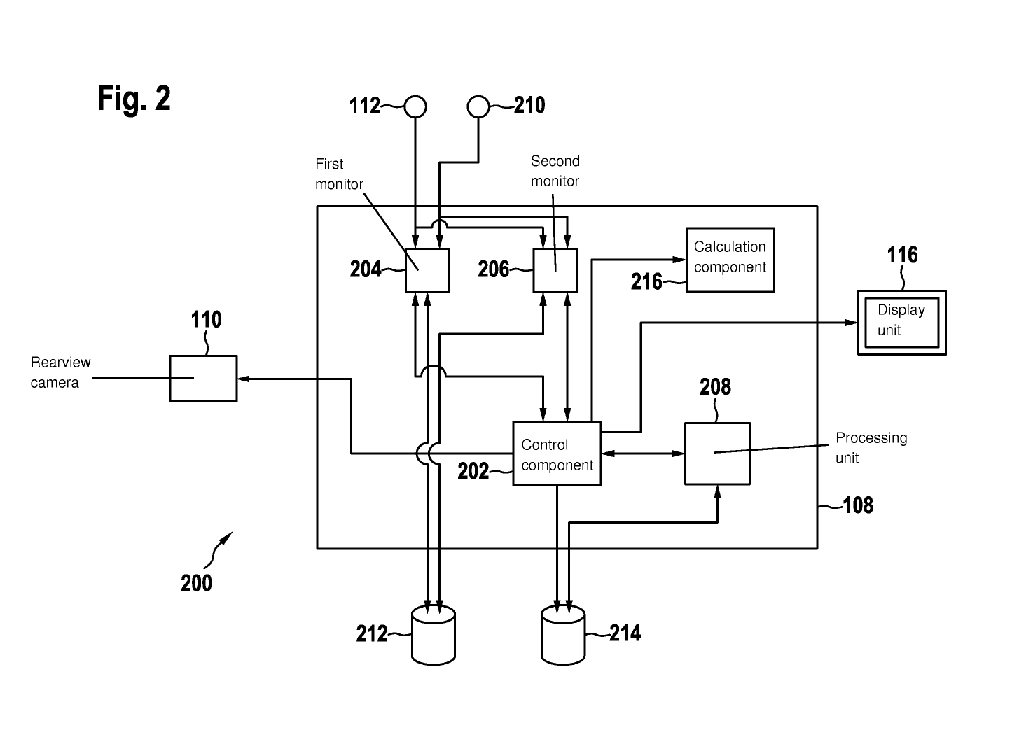

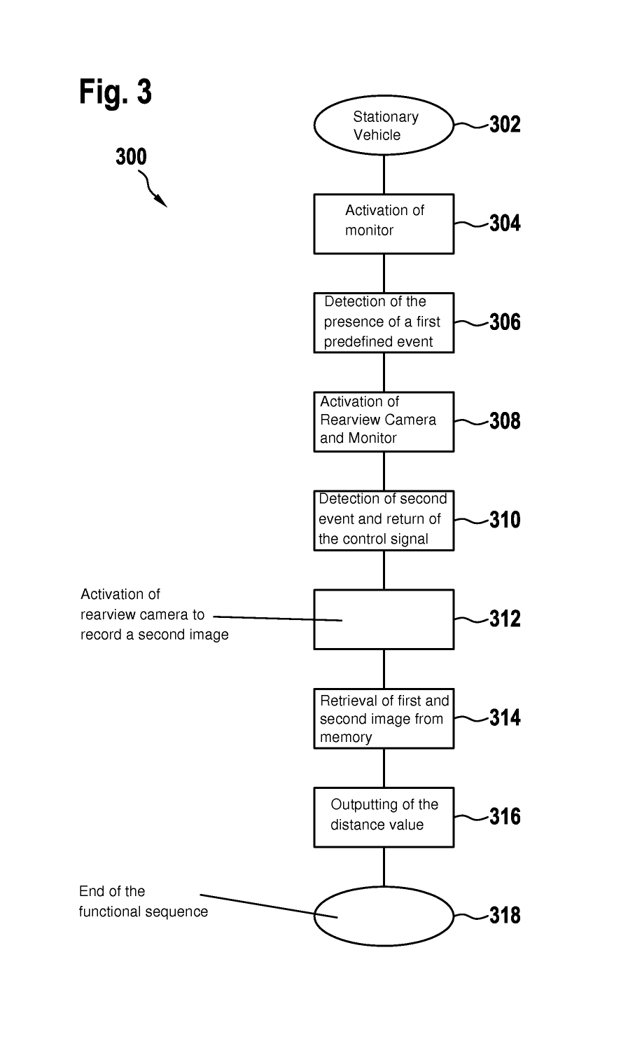

FIG. 2 shows further details of driver assistance system 106 from FIG. 1 in the form of a functional block diagram, in particular, those components which cooperate to realize a parking assistance system 200. To this end, ECU 108 has the following components: a control component 202, a first monitor 204, a second monitor 206, as well as a processing unit 208. The manner in which the components of parking assistance system 200 shown in FIG. 2 cooperate is described with reference to the flow chart of FIG. 3. The method is used for determining distance 120 (compare FIG. 1) to an object, such as parking-space limiting object 102 in the rear surrounding field of vehicle 100, while vehicle 100 is still stationary (302).

FIG. 2 shows further details of driver assistance system 106 from FIG. 1 in the form of a functional block diagram, in particular, those components which cooperate to realize a parking assistance system 200. To this end, ECU 108 has the following components: a control component 202, a first monitor 204, a second monitor 206, as well as a processing unit 208. The manner in which the components of parking assistance system 200 shown in FIG. 2 cooperate is described with reference to the flow chart of FIG. 3. The method is used for determining distance 120 (compare FIG. 1) to an object, such as parking-space limiting object 102 in the rear surrounding field of vehicle 100, while vehicle 100 is still stationary (302).

In step 306, monitor 204 detects the presence of first predefined event. Predefined conditions are to be fulfilled in order to establish the presence of the event. These are loaded from a memory area 212 assigned to ECU 108 upon activation of monitor 204 in step 304. The conditions relate to data provided by sensors 112, 210. If the data supplied by sensors 112, 210 correspond to the requirements, the existence of the predefined event is detected, and monitor 204 transmits a detection signal to that effect to control component 202.

In the example described here, sensor 112 records a state of driver-side door 114 (compare FIG. 1), i.e., sensor 112 supplies data indicating whether driver-side door 114 is open or closed. The condition monitored by monitor 204 may include that driver-side door 114 be opened. If sensor 112 signals data to this effect, the monitor ascertains the presence of the predefined event. It is assumed here that a driver enters vehicle 100 shortly after the driver-side door opens, which results in a pitching motion of vehicle 100. Parking assistant 100 utilizes this pitching motion to measure distance 120 to vehicle 102 parked behind the same.

Additionally or alternatively, the monitor may also receive data from a sensor (not shown) which monitors a locking state of door 114. If this sensor reports an unlocking of the door to monitor 204, for example, and if a predefined condition is fulfilled by this datum, this may also contribute to the presence of an event being determined that is associated with a (subsequent) pitching motion, (i.e., if an event exists, a subsequent pitching motion of vehicle 100 is probable, so that it is expedient that parking assistant 200 be activated to perform the distance measurement).

In the exemplary embodiment discussed here, the monitor receives data from further sensor system 210 that is located on at least one wheel suspension of the vehicle. When a person enters vehicle 100, the vehicle lowers in response thereto. This may be measured on the basis of the change in the state of a suspension on a wheel suspension. If sensor system 210 (which may also include a plurality of sensors on a plurality of wheel suspensions) transmits information to this effect to monitor 204, it may assess that such a condition is met in accordance with which the vehicle begins to sink down.

In this example, the conditions, on the basis of which the presence of a first event is established, include the opening of the driver door (sensor 112), as well as the beginning of the lowering of the vehicle (sensor 210). From this, it is inferred that the vehicle at this point executes a pitching motion in response to the driver getting in, and that the parking assistant should utilize this pitching motion to carry out a distance measurement. In this example, the opening of the driver door alone does not suffice to perform the distance measurement. Thus, for example, the driver door could be opened without there being any intention to leave parking position 101, so that a distance measurement is not needed. In the same way, an isolated lowering of the vehicle also does not mean that the intention is to leave the parking position. For example, there could be merely one person who is entering on the passenger side.

However, if someone opens driver-side door 114 and sits down on the driver-side seat, so that vehicle 100 begins to sink down, the data transmitted by sensors 112, 210 correspond with the corresponding conditions, and monitor 204 transmits a control signal to that effect to control component 202.

In step 308, control unit 202—triggered by the control signal received by monitor 204—activates rearview camera 110. In response to the activation, camera 110 produces a first image of rear vehicular environment 122 (FIG. 1) of vehicle 100; object 102, in particular, appearing in the image field in a first position (in particular, apparent height). On the basis of the implementation described above, the first image is taken immediately following the begin of the pitching motion of vehicle 100, as is caused by a person getting into vehicle 100. Camera 110 transmits the recorded image to control unit 202 that buffer-stores the first image in a memory area 214. Alternatively, camera 110 may intermediately store the image directly in memory area 214.

In step 308, camera 110 is activated for merely a short period of time to capture the first image, and is then deactivated again. At the same time, control unit 202 activates monitor 206 in step 308. It likewise receives data from sensors 112 and 210, however, compares these to another set of conditions that monitor 206 obtains from event memory 212. The conditions include that 1) driver-side door 114 is closed, and 2) that the lowering of the vehicle ceases (because the person has fully entered the vehice). A corresponding change in the data supplied by sensor 112 makes it possible to determine that the first condition is fulfilled. The data supplied by wheel suspension sensor system 210 make it possible to establish that the second condition is fulfilled, for example, by indicating that vehicle 100 has ceased the downward motion thereof (or is in the process of reversing to an upward motion). If both of the aforementioned conditions are met, then, in step 310, monitor 206 detects the existence of the second event and returns a control signal to this effect to control unit 202.

Triggered by the control signal received by monitor 206, control unit 202 activates rearview camera 110 once again in step 312 to record a second image of rear vehicular environment 122. Object 102 is again imaged in the process. However, the (in particular, vertical) position of vehicle 102 in the second image is shifted relative to the first image due to the pitching motion of vehicle 100 that occurred between the first and the second image. Via control unit 202, camera 110 supplies or directs the second image to intermediate memory 214.

In step 314, processing unit 208 receives a control signal from control unit 202 and subsequently retrieves the first and second image from memory 214. Processing unit 208 determines a distance to object 102 on the basis of the apparent vertical and/or angular displacement of this object between the first and the second image. To this end, an absolute motion of camera 110 in the vertical direction is determined on the basis of the pitching motion of vehicle 100. For this purpose, control unit 208 receives data of wheel suspension sensor system 210 (alternatively, processing unit 208 could also receive those data of sensor 210 from monitors 204 and 206 which have resulted in detection of the first, respectively second event there in each case). These data, which. pertain to the lowering of vehicle 100, make it possible to infer the actual vertical and/or angular movement of camera 100 on the basis of the known installation location of camera 110 in vehicle 100. From this, as well as from the displacement of vehicle 102 in the field of view of camera 110, it is possible to ascertain an estimated value for the distance to vehicle 102.

In step 316, control unit 202 outputs the distance value supplied by processing unit 208. The outputting may be to an HMI (human-machine interface) of driver assistance system 106, for example, that includes display unit 116 and, in some instances, further output units, such as a loudspeaker. Moreover, control unit 202 may also transmit the ascertained distance value to a further calculation component 216 of parking assistant 200, which, on the basis, inter alia, of the ascertained distance value for vehicle 100, calculates a trajectory from parking space 101. Control unit 202 ends the functional sequence in step 318. The system may be reactivated in step 304, for example, in the case of a subsequent parking.

While in the exemplary embodiment discussed above with reference to FIG. 2, two sensor systems 112, 210 were used for monitors 204, 206, as well as for the distance calculation in component 208, fewer sensors may be consulted in other exemplary embodiments. For example, merely one single sensor, such as door-opening sensor 112 may be used. In yet other exemplary embodiments, sensors other than those described above and/or more than two sensors may be used.

In the exemplary embodiment discussed with reference to FIG. 2, the camera is not continuously activated, rather is separately and briefly activated in each case only to record the first, respectively second image. Alternatively, control unit 202 could also activate rearview camera 210 at a set time following detection of the first event by monitor 204; this could eliminate the need for second monitor 206. In this method, the time period should be dimensioned to be long enough to ensure that the pitching motion is completely ended; thus, for example, that it take place approximately five seconds after the opening of the driver-side door or the driver getting into the vehicle.

The need for second monitor 206 could also be eliminated in the case of a continuous activation of rearview camera 110 in response to the detection of the first event. In this case, however, from the continuous image sequence taken by camera 110, processing component 208 would have to determine a second image, in the case of which, for instance, the displacement and/or pivoting of camera 110 reaches its maximum, in order to reach a maximal optical flow and thus a highest possible accuracy of the distance determination.

The above discussion related to the use of rearview camera 110 for determining the distance between vehicle 100 and an object 102 behind the rear-end section of vehicle 100. Similarly, a forwardly directed camera (not shown in FIG. 1) could determine a distance between vehicle 100 and parking gap-limiting object 104.

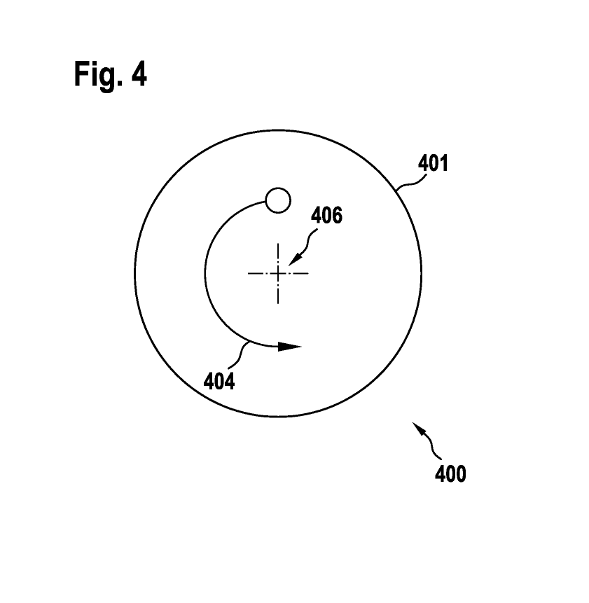

In schematic form, FIG. 4 shows a front view of a camera 400 which, for example, could be an implementation of rearview camera 112 from FIG. 1. Camera 400 includes a cylindrical housing 401, of which FIG. 4 depicts a front view. A light entry 402, for example, a lens or an objective lens, is located at the front end of housing 401. As indicated by arrow 404, light entry 402 is rotatable about an axis of rotation 406. For example, housing 401 could be rotationally mounted. Axis of rotation 406 may extend in parallel to the ground, for example, and parallel to a direction, as indicated by distance arrow 120 in FIG. 1.

For the distance determination, camera 400 would record a first image in the position shown in FIG. 4, and, following a 180° rotation—as indicated by arrow 404—record a second image. The rotation could be initiated immediately following recording of the first image. The recording of the second image following a pitching motion would be triggered using a to method as described above, and would take place in the rotated position. An optical flow generated by the pitching motion would hereby be amplified between the first and the second image.

Alternatively, it is also possible to use a camera having a rotatable, respectively pivoting light entry, as shown in FIG. 4, as the only element (i.e., without pitching motion), in order to generate an optical flow and to hereby render possible a distance determination in the case of a stationary vehicle equipped with a mono-camera. In comparison to the related art discussed at the outset, this approach is advantageous since the need for a complex and error-prone rail system may be eliminated; merely a (rotatable, respectively pivotable camera) is required.

The present invention is not limited to the exemplary embodiments described here and the aspects emphasized therein. Rather, a multiplicity of modifications are possible that reside within the scope of expert activity.

1. 10. (canceled)

11. A camera-based method for determining a distance to an object in a vehicular environment in the case of a vehicle at a standstill, comprising:
detecting a first predefined event that occurs in connection with a pitching motion of the vehicle, the first event including at least one of the following events: unlocking of a vehicle door, opening of a vehicle door, change in a weight loading upon a vehicle seat, and lowering of the vehicle;
activating a camera in response to the detection of the first event in order to record a first image and a second image of the vehicular environment and include a time reference to the pitching motion;
processing the first image and the second image in order to determine a distance to the object from a displacement of the object in a field of view of the camera that has taken place between a point in time of recording the first image and a point in time of recording the second image in response to the pitching motion; and
determining an absolute displacement of the camera in response to the pitching motion, and a specific absolute displacement in the determination of the distance to the object.

12. The method as recited in claim 11, wherein:
the first image is recorded one of before and during the pitching motion, and
the second image is recorded subsequently to the recording of the first image and one of during and subsequently to the pitching motion.

13. The method as recited in claim 11, wherein:
the second image is recorded in response to a detection of a second event that is associated with the pitching motion.

14. The method as recited in claim 13, wherein the second event includes at least one of the following events: closing of a vehicle door, constant weight loading upon a vehicle seat, the vehicle one of at rest and executing an upward movement, a starting of the engine, and an engagement of a gear.

15. The method as recited in claim 11, the camera is a rearview camera of a parking assistance system of the vehicle.

16. A computer program for implementing a method for determining a distance to an object in a vehicular environment in the case of a vehicle at a standstill, comprising instructions for performing the following:
detecting a first predefined event that occurs in connection with a pitching motion of the vehicle, the first event including at least one of the following events: unlocking of a vehicle door, opening of a vehicle door, change in a weight loading upon a vehicle seat, and lowering of the vehicle;
activating a camera in response to the detection of the first event in order to record a first image and a second image of the vehicular environment and include a time reference to the pitching motion;
processing the first image and the second image in order to determine a distance to the object from a displacement of the object in a field of view of the camera that has taken place between a point in time of recording the first image and a point in time of recording the second image in response to the pitching motion; and
determining an absolute displacement of the camera in response to the pitching motion, and a specific absolute displacement in the determination of the distance to the object, wherein the computer program is executed on a programmable computer device.

17. A parking assistance system, comprising:
a camera for determining a distance to an object in a vehicular environment in the case of a vehicle at a standstill;
a component for detecting a first predefined event that occurs in connection with a pitching motion of the vehicle;
a component for activating the camera in response to the detection of the first event in order to record a first image and a second image of the vehicular environment and include a time reference to the pitching motion;
a component for processing the first image and the second image in order to determine the distance to the object from a displacement of the object in a field of view of the camera that has taken place between a point in time of the recording of the first image and a point in time of the recording of the second image in response to the pitching motion; and
at least one wheel suspension sensor for measuring a vertical displacement of the vehicle.

18. The parking assistance system as recited in claim 17, wherein:
the camera is movably mounted on the vehicle in a way that allows a rotational motion of the camera relative to the vehicle to support the distance determination
